(19) United States
(12) Patent Application Publication
(10) Pub. No.: US 2006/0018471 A1
(43) Pub. Date: Jan. 26, 2006

(54) Information recording apparatus and method, information reproducing apparatus and method, information recording/reproducing apparatus and method, and computer program product

(75) Inventor: Kenichiro Tada, Tokorozawa-Shi (JP)

Correspondence Address: YOUNG & THOMPSON, 745 SOUTH 23RD STREET, 2ND FLOOR, ARLINGTON, VA, 22202, US

(73) Assignee: PIONEER CORPORATION, Tokyo (JP)

(21) Appl. No.: 11/177,396

(22) Filed: Jul. 11, 2005

(30) Foreign Application Priority Data
Jul. 9, 2004 (JP) 2004-203154

(51) Int. Cl. H04N 7/167

(52) U.S. Cl. 380/228

(57) ABSTRACT

An information recording apparatus for performing MOVE processing of moving first content information having a first reproduction quality, which is recorded on a first recording medium, to a second recording medium, the information recording apparatus provided with: a scramble device for performing scramble processing of scrambling the first content information on the basis of a predetermined scramble key, to thereby generate scramble information; an identifier storing device for storing an identifier to identify the second recording medium which is a MOVE destination of the first content information; and a history information generating device for generating history information which indicates a history of each of the MOVE processing and the scramble processing.

### BACKGROUND OF THE INVENTION

1. Field of the Invention

The present invention relates to an information recording apparatus and an information recording method, an information reproducing apparatus and an information reproducing method, such as a DVD recorder and a DVD player, and a computer program product which makes a computer function as the information recording apparatus and the like.

2. Description of the Related Art

Now, terrestrial digital broadcasting and BS digital broadcasting or the like are started, and even at home, an environment for watching high definition digital broadcasting is being improved. In such digital broadcasting, it is possible for users to watch Hi-vision broadcasting or content information having the quality of HDTV (hereinafter referred to HD (High Definition)), which advances from so-called standard broadcasting or content information having the quality of SDTV (hereinafter referred to as SD (Standard Definition)).

On the other hand, the content information broadcasted by such digital broadcasting is digital data, so that duplicating or copying does not deteriorate image quality, and it is possible to make a copy, easily. Thus, the copying of the digital data (or the content information related to the digital broadcasting) is an issue in regard to copyright protection. In order to realize such copyright protection, various technologies for copyright protection have been developed (refer to Japanese Patent Application Laid Open NO. 2000-324443, NO. 2000-298926, and NO. H09-171658). In particular, CPPM (Content Protection for Prerecorded Media) and CPRM (Content Protection for Recording Media) in the technologies for copyright protection, which are adopted on recording media, such as a DVD, are intended to prevent illegal copying, in which the copyright of the content information is properly protected by imposing a copy-once restriction on the content information.

### SUMMARY OF THE INVENTION

The “copy-once limitation” has been put on all programs (or content information) broadcasted in Japan from April, 2004, in the terrestrial digital broadcasting and the BS digital broadcasting, in order to protect the copyrights.

This “copy-once limitation” allows a so-called “MOVE processing (i.e. MOVE operation)” only in which the original content information recorded in a hard disk or the like is deleted, if the content information recorded in the hard disk is moved into/onto another record medium such as the DVD. For example, some users tend to record HD content information into a hard disk at home and then record this HD content information into a DVD or the like in order to enjoy this content anywhere out of home. In this case, the HD content information recorded in the hard disk is recorded as another SD content information into the DVD or the like and this original HD content information is deleted from the hard disk, in conformity with the MOVE operation. This MOVE operation allows transferring the content information with the “copy-once limitation” into/onto another record medium, while suitably protecting the copyright of the content information.

In this case, even if the user wants to enjoy the HD content information again, it is impossible to enjoy the HD content information, because there is remained only the SD content information. Such a situation is inconvenient in that it may prevent a spread of the digital broadcasting, and may detract advantages of information devices such as hard disk recorders.

It is therefore an object of the present invention to provide: an information recording apparatus and an information recording method, an information reproducing apparatus and an information reproducing method, an information recording/reproducing apparatus and an information recording/reproducing method, which enable a user to preferably watch the content information while preferably protecting the copyright, and a computer program product which makes a computer function as the information recording apparatus and the like.

(Information Recording Apparatus)

The above object of the present invention can be achieved by an information recording apparatus for performing MOVE processing of moving first content information having a first reproduction quality, which is recorded on a first recording medium, to a second recording medium, the information recording apparatus provided with: a scramble device for performing scramble processing of scrambling the first content information on the basis of a predetermined scramble key, to thereby generate scramble information; an identifier storing device for storing an identifier to identify the second recording medium which is a MOVE destination of the first content information; and a history information generating device for generating history information which indicates a history of each of the MOVE processing and the scramble processing.

According to the information recording apparatus of the present invention, by the operation of the scramble device, the scramble processing is performed with respect to the first content information, on the basis of the predetermined scramble key. As a result, the scramble information is generated from the first content information. Here, the “scramble processing” of the present invention indicates converting the content information which indicates a predetermined video or the like to information which itself cannot indicate the predetermined video or the like (i.e. the scramble information). Namely, the scramble information itself does not indicate the content information. The scramble information becomes information for indicating various videos and audios or the like (specifically, the first content information) only after the data processing together with the scramble key is performed. Therefore, in so far as the scramble information is generated, it is possible to protect the copyright of the content (i.e. it is possible to satisfy the copy-once limitation), properly.

In particular, in the embodiment, by the operation of the identifier storing device, the identifier for uniquely identifying the second recording medium, which is the destination of the MOVE processing which moves the first content information, is stored. In addition, by the operation of the history information generating device, the history information is generated. The history information indicates a history about the scramble processing (e.g. how the scramble processing is performed by using what type of scramble key, as described later) and a history about the MOVE processing (e.g. which first content information is MOVE-processed by which apparatus from which recording medium to which recording medium or the like, as described later).

Thus, as described later, in generating the first content information from the scramble information on the basis of the scramble key, it is possible to preferably reproduce the first content information to which the scramble processing or the MOVE processing is properly performed, by referring to the identifier and the history information. In the meanwhile, it is possible to preferably prevent the illegal reproduction of the first content information or the like from the illegally copied or duplicated scramble information or the like, by referring to the identifier and the history information. For example, in the case that the reproduction of the second recording medium, as for which it is found out that the first content information is not properly MOVE-processed by referring to the identifier stored in the identifier storing device, is instructed, it is possible to prevent the illegal reproduction. By this, it is possible to protect the copyright of the content, more preferably.

Therefore, while the copyright of the content is preferably protected, a user can watch the first content information having the first reproduction quality, again, on the basis of the scramble information, even after the first content information is down-converted to a content information having the lower definition second reproduction quality (e.g. second content information, described later) and the content information after down-converting is recorded onto another recording medium. Namely, even if a relatively high definition digital broadcasted program is recorded onto the first recording medium, and then, the program is down-converted to a relatively low definition program and recorded onto the second recording medium, it is possible to watch the relatively high definition digital broadcasted program again. Obviously, it is also possible to watch the low definition program.

Consequently, according to the information recording apparatus of the present invention, a user can watch the content information, preferably, while the copyright of the content is preferably protected.

In one aspect of the information recording apparatus of the present invention, it is further provided with: a down-convert device for down-converting the first content information, to thereby generate second content information having a second reproduction quality which is lower quality than the first reproduction quality; a first recording device for recording the second content information onto the second recording medium; and a deleting device for deleting the first content information recorded on the first recording medium if the second content information is recorded onto the second recording medium.

According to this aspect, by the operation of the down-convert device, the first content information having the first reproduction quality (HD) recorded on the first recording medium is down-converted, to thereby generate the second content information having the second reproduction quality (SD). At this time, the second reproduction quality is lower quality (i.e. lower definition), as compared to the first reproduction quality, so that the data size of the second content information is smaller than that of the first content information. The generated second content information is recorded onto the second recording medium, by the operation of the first recording device.

On the other hand, after the second content information is recorded onto the second recording medium, the first content information recorded on the first recording medium is deleted, by the operation of the deleting device. By this, it is possible to conform to the standard of the MOVE processing and to protect the copyright of the content, properly.

Consequently, according to the information recording apparatus of the present invention, a user can watch the content information having the desired reproduction quality (e.g. the first reproduction quality corresponding to a HD image quality described later, or the second reproduction quality corresponding to a SD image quality described later), preferably, while the copyright of the content is preferably protected.

In an aspect of the information recording apparatus provided with the first recording device and the like, as described above, the first recording device may further record the generated history information onto the second recording medium.

By such a construction, the history information is recorded onto the second recording medium onto the first content information is properly MOVE-processed. Therefore, even if only the history information is illegally copied, it is impossible to reproduce the first content information or the like by using the illegally copied history information, because of not using the second recording medium onto which the first content information is properly MOVE-processed, as described later. Therefore, it is possible to protect the copyright of the content, more preferably.

In another aspect of the information recording apparatus of the present invention, the history information includes information which can specify at least one of the scramble key, the information recording apparatus which performs the MOVE processing, the first content information to which the MOVE processing is performed (i.e. the MOVE-processed first content information), and a recording position of the second content information to which the MOVE processing is performed (i.e. the MOVE-processed second content information) on the second recording medium.

According to this aspect, it is possible to prevent the illegal reproduction of the first content information or the like, more effectively, by referring to the history information, as occasion demands. Therefore, the copyright of the content can be protected, preferably. Furthermore, the history information may include information about the second recording medium which is the MOVE destination, or the like.

In another aspect of the information recording apparatus of the present invention, the identifier is peculiar information to the second recording medium.

According to this aspect, it is possible to uniquely specify the second recording medium onto which the first content information is properly MOVE-processed, by referring to the identifier. Therefore, it is possible to prevent the reproduction of the illegally copied content information from the second recording medium, more effectively, by referring to the identifier.

In another aspect of the information recording apparatus of the present invention, it is further provided with: a second recording device for recording the scramble information onto the first recording medium.

According to this aspect, it is possible to perform various operations described later (specially, the generation operation of the first content information), properly, by using the scramble information recorded on the first recording medium.

In another aspect of the information recording apparatus of the present invention, it is further provided with: a key generating device for generating the scramble key.

According to this aspect, by the operation of the key generating device, it is possible to generate the scramble key which can protect the copyright of the content, more preferably, or which is more secure. Alternatively, a different scramble key can be prepared in each scramble processing.

In another aspect of the information recording apparatus of the present invention, it is further provided with: an extracting device for extracting the scramble information on the basis of a difference in data structures of the first content information and the scramble information; and a displaying device for displaying a list of the extracted scramble information.

According to this aspect, it is possible to selectively extract (or list up or categorized) the scramble information from the first content information and the scramble information which can be mixed and recorded on the first recording medium, for example, on the basis of the difference in the data structures of the first content information and the scramble information. Then, the list of the scramble information which will be recorded onto the first recording medium or the like may be displayed, to let a user input an instruction for deleting the predetermined scramble information or the like, for example.

In another aspect of the information recording apparatus of the present invention, it is further provided with a key generating device for generating the scramble key on the basis of readable information from at least the second recording medium.

According to this aspect, it is possible to generate the scramble key peculiar to the second recording medium onto which the second content information is recorded, for example. In other words, in order to generate the scramble key, for example, the second recording medium onto which the second content information is actually and properly recorded is necessary. Namely, the “scramble key” herein is a key which cannot be generated without based on the information read from at least the second recording medium. In other words, the “scramble key” herein is a key which cannot be generated without based on the information read from at least the second recording medium on which the second content information is actually and properly recorded. Thus, it is possible to prevent the illegal generation (duplication or copying) of the scramble key, more effectively. Therefore, even if someone illegally obtains the scramble data, the person cannot easily duplicate or copy the scramble key. As a result, it is possible to protect the copyright of the content, more preferably.

In an aspect of the information recording apparatus provided with the key generating device, the readable information may include peculiar information to the second recording medium onto which the second content information is recorded. Moreover, the readable information may include at least one portion of the second content information. Furthermore, the readable information may include at least one portion of an encryption key used for the protection of the copyright of the first content information. Furthermore, the readable information may include information required for the generation of the encryption key.

By such a construction, it is possible to prevent the illegal generation (duplication or copying) of the scramble key, more effectively or more strongly. As a result, it is possible to protect the copyright of the content, more preferably.

(Information Recording Method)

The above object of the present invention can be also achieved by an information recording method of performing MOVE processing of moving first content information having a first reproduction quality, which is recorded on a first recording medium, to a second recording medium, the information recording method provided with: a scramble process of performing scramble processing of scrambling the first content information on the basis of a predetermined scramble key, to thereby generate scramble information; an identifier storing process of storing an identifier to identify the second recording medium which is a MOVE destination of the first content information; and a history information generating process of generating history information which indicates a history of each of the MOVE processing and the scramble processing.

According to the information recording method of the present invention, it is possible to receive the same various benefits as those of the above-mentioned information recording apparatus of the present invention.

Incidentally, in response to various aspects in the above-mentioned information recording apparatus of the present invention, the information recording method of the present invention can also adopt various aspects.

(Information Reproducing Apparatus)

The above object of the present invention can be also achieved by an information reproducing apparatus for reproducing first content information which is moved onto a second recording medium by the above-mentioned information recording apparatus of the present invention (including its various aspects), the information reproducing apparatus provided with: a first judging device for judging whether or not an identifier of the second recording medium which is a reproduction object by the information reproducing apparatus is included in the identifier, which is stored in the identifier storing device, of the second recording medium which is the MOVE destination of the first content information; an obtaining device for obtaining the history information if it is judged that the identifier of the second recording medium which is the reproduction object is included in the identifier of the second recording medium which is the MOVE destination of the first content information (i.e. the identifier which is stored in the identifier storing device), by the judging device; a content information generating device for generating the first content information on the basis of each of the scramble information and the scramble key which are specified by the history information; and a reproducing device for reproducing the generated first content information.

According to the information reproducing apparatus of the present invention, it is possible to generate the first content information by using the scramble information and the scramble key which are specified by the history information. Before this operation, by the operation of the first judging device, it is judged whether or not the identifier of the second recording medium which is the reproduction object (i.e. which is loaded onto the information reproducing apparatus) is included in the identifier stored in the identifier storing device. In other words, by the operation of the first judging device, it is judged whether or not the identifier of the second recording medium which is the reproduction object coincides with at least one identifier from among a group of identifiers stored in the identifier storing device. Namely, it is judged whether or not the second recording medium which is properly MOVE-processes is loaded onto the information reproducing apparatus. As a result, only if it is judged that the identifier of the second recording medium which is the reproduction object is included in the identifier or the like stored in the identifier storing device, the history information can be obtained from the second recording medium. Therefore, the history information cannot be obtained from the second recording medium on which the history information is illegally recorded or the MOVE-processed content (specifically, the second content information) is illegally recorded. As a result, the first content information cannot be even generated from the scramble information. In the case of the judgment of “included”, by the operation of the content information generating device, it is possible to generate the original first content information, by performing the descramble processing (or scramble cancellation or removal processing) with respect to the scramble information on the basis of the scramble key. Therefore, even if once converting the first content information to the second content information which is lower definition, for example, and then recording it onto another recording medium, a user can watch the first content information again.

Consequently, according to the information reproducing apparatus of the present invention, while the copyright of the content is properly protected, a user can watch the content information related to the desired reproduction quality (specially, the first reproduction quality), preferably.

Incidentally, in response to various aspects in the above-mentioned information recording apparatus of the present invention, the information reproducing apparatus of the present invention can also adopt various aspects.

In one aspect of the information reproducing apparatus of the present invention, the history information is recorded on the second recording medium, the obtaining device obtains the history information from the second recording medium, the information reproducing apparatus is further provided with a second judging device for judging whether or not it is possible to reproduce the first content information on the information reproducing apparatus by referring to the obtained history information, and the content information generating device generates the first content information if it is judged that it is possible to reproduce the first content information on said information reproducing apparatus, by the second judging device.

According to this aspect, it is possible to prevent such a disadvantage that the illegally copied scramble information is descrambled, more effectively, by referring to the history information. Namely, not only the validness (or legality) of the second recording medium (e.g. the validness of whether it is properly MOVE-processed) is confirmed by using the identifier, but also the validness of the second recording medium and the information reproducing apparatus or the like is confirmed by using the history information. Therefore, while the copyright of the content is protected, more preferably, it is possible to reproduce the first content information or the like, preferably.

In another aspect of the information reproducing apparatus of the present invention, it is further provided with: an extracting device for extracting the scramble information on the basis of a difference in data structures of the first content information and the scramble information; and a displaying device for displaying a list of the extracted scramble information.

According to this aspect, it is possible to selectively extract (or list up or categorized) the scramble information from the first content information and the scramble information which can be mixed and recorded on the first recording medium, for example, on the basis of the difference in the data structures of the first content information and the scramble information. Then, the list of the scramble information which will be recorded onto the first recording medium or the like may be displayed, to let a user input an instruction for deleting the predetermined scramble information or the like, for example.

In another aspect of the information reproducing apparatus of the present invention, it is further provided with a second reproducing device for reproducing the second content information.

According to this aspect, a user can also watch the second content information, properly.

(Information Reproducing Method)

The above object of the present invention can be also achieved by an information reproducing method of reproducing first content information which is moved onto a second recording medium by the above-mentioned information recording apparatus of the present invention (including its various aspects), the information reproducing method provided with: a first judging process of judging whether or not an identifier of the second recording medium which is a reproduction object by the information reproducing apparatus is included in the identifier, which is stored in the identifier storing device, of the second recording medium which is the MOVE destination of the first content information an obtaining process of obtaining the history information if it is judged that the identifier of the second recording medium which is the reproduction object is included in the identifier of the second recording medium which is the MOVE destination of the first content information, by the judging process; a content information generating process of generating the first content information on the basis of each of the scramble information and the scramble key which are specified by the history information; and a reproducing process of reproducing the generated first content information.

According to the information reproducing method of the present invention, it is possible to receive the same various benefits as those of the above-mentioned information reproducing apparatus of the present invention.

Incidentally, in response to various aspects in the above-mentioned information reproducing apparatus of the present invention, the information reproducing method of the present invention can also adopt various aspects.

(Information Recording/Reproducing Apparatus)

The above object of the present invention can be also achieved by an information recording/reproducing apparatus for performing MOVE processing of moving first content information having a first reproduction quality, which is recorded on a first recording medium, to a second recording medium, the information recording/reproducing apparatus provided with: a scramble device for performing scramble processing of scrambling the first content information on the basis of a predetermined scramble key, to thereby generate scramble information; an identifier storing device for storing an identifier to identify the second recording medium which is a MOVE destination of the first content information; a history information generating device for generating history information which indicates a history of each of the MOVE processing and the scramble processing; a first judging device for judging whether or not an identifier of the second recording medium which is a reproduction object by the information reproducing apparatus is included in the identifier, which is stored in the identifier storing device, of the second recording medium which is the MOVE destination of the first content information; an obtaining device for obtaining the history information if it is judged that the identifier of the second recording medium which is the reproduction object is included in the identifier of the second recording medium which is the MOVE destination of the first content information, by the judging device; a content information generating device for generating the first content information on the basis of each of the scramble information and the scramble key which are specified by the history information; and a reproducing device for reproducing the generated first content information.

According to the information recording/reproducing apparatus of the present invention, it is possible to receive the same various benefits as those of each of the above-mentioned information recording apparatus and the information reproducing apparatus of the present invention.

Incidentally, in response to various aspects in the above-mentioned information recording apparatus or information reproducing apparatus of the present invention, the information recording/reproducing apparatus of the present invention can also adopt various aspects.

In one aspect of the information recording/reproducing apparatus of the present invention, the history information including information which can specify an information recording/reproducing apparatus which performs the MOVE processing is recorded on the second recording medium, the obtaining device obtains the history information from the second recording medium, the information recording/reproducing apparatus is further provided with a second judging device for judging whether or not the information recording/reproducing apparatus specified by the obtained history information coincides with the information recording/reproducing apparatus, and the content information generating device generates the first content information if it is judged that the information recording/reproducing apparatus specified by the obtained history information coincides with said information recording/reproducing apparatus, by the second judging device.

According to this aspect, it is possible to prevent such a disadvantage that the illegally copied scramble information is descrambled, more effectively, by referring to the information which can specify an information recording/reproducing apparatus which performs the MOVE processing and which is included in the history information. Namely, not only the validness of the second recording medium (e.g. the validness of whether it is properly MOVE-processed) is confirmed by using the identifier, but also the validness of the information recording/reproducing apparatus is confirmed by using the history information (e.g. the validness of whether the MOVE processing is properly performed onto the second recording medium). Therefore, while the copyright of the content is protected, preferably, it is possible to reproduce the first content information or the like, preferably.

In another aspect of the information recording/reproducing apparatus of the present invention, it is further provided with: an extracting device for extracting the scramble information on the basis of a difference in data structures of the first content information and the scramble information; and a displaying device for displaying a list of the extracted scramble information.

According to this aspect, it is possible to selectively extract (or list up or categorize) the scramble information from the first content information and the scramble information which can be mixed and recorded on the first recording medium, for example, on the basis of the difference in the data structures of the first content information and the scramble information. Then, the list of the scramble information which will be recorded onto the first recording medium or the like may be displayed, to let a user input an instruction for deleting the predetermined scramble information or the like, for example.

(Information Recording/Reproducing Method)

The above object of the present invention can be also achieved by an information recording/reproducing method of performing MOVE processing of moving first content information having a first reproduction quality, which is recorded on a first recording medium, to a second recording medium, the information recording/reproducing method provided with: a scramble process of performing scramble processing of scrambling the first content information on the basis of a predetermined scramble key, to thereby generate scramble information; an identifier storing process of storing an identifier to identify the second recording medium which is a MOVE destination of the first content information; a history information generating process of generating history information which indicates a history of each of the MOVE processing and the scramble processing; a first judging process of judging whether or not an identifier of the second recording medium which is a reproduction object by the information reproducing apparatus is included in the identifier, which is stored in the identifier storing device, of the second recording medium which is the MOVE destination of the first content information; an obtaining process of obtaining the history information if it is judged that the identifier of the second recording medium which is the reproduction object is included in the identifier of the second recording medium which is the MOVE destination of the first content information, by the judging process; a content information generating process of generating the first content information on the basis of each of the scramble information and the scramble key which are specified by the history information; and a reproducing process of reproducing the generated first content information.

According to the information recording/reproducing method of the present invention, it is possible to receive the same various benefits as those of each of the above-mentioned information recording apparatus and the information reproducing apparatus of the present invention.

Incidentally, in response to various aspects in the above-mentioned information recording apparatus or information reproducing apparatus of the present invention, the information recording/reproducing method of the present invention can also adopt various aspects.

(Computer Program Product)

The above object of the present invention can be also achieved by a first computer program product in a computer-readable medium for tangibly embodying a program of instructions executable by a computer to make the computer function as at least one portion of the above-mentioned information recording apparatus (including its various aspects). The above object of the present invention can be also achieved by a second computer program product in a computer-readable medium for tangibly embodying a program of instructions executable by a computer to make the computer function as at least one portion of the above-mentioned information reproducing apparatus (including its various aspects). The above object of the present invention can be also achieved by a third computer program product in a computer-readable medium for tangibly embodying a program of instructions executable by a computer to make the computer function as at least one portion of the above-mentioned information recording/reproducing apparatus (including its various aspects).

According to each of the first to third computer program product of the present invention, the information recording apparatus, the information reproducing apparatus, or the information recording/reproducing apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, each computer program product may include computer readable codes to cause the computer (or may comprise computer readable instructions for causing the computer) to function as the information recording apparatus, the information reproducing apparatus, or the information recording/reproducing apparatus described above.

Incidentally, in response to various aspects in the information recording apparatus, the information reproducing apparatus, or the information recording/reproducing apparatus of the present invention, each of the first to third computer program products of the present invention can also adopt various aspects.

The nature, utility, and further features of this invention will be more clearly apparent from the following detailed description with reference to preferred embodiments of the invention when read in conjunction with the accompanying drawings briefly described below.

As explained above, according to the information recording apparatus, it is provided with: the scramble device; the identifier storing device; and the history information generating device. According to the information recording method, it is provided with: the scramble process; the identifier storing process; and the history information generating process. Moreover, according to the information reproducing apparatus, it is provided with: the first judging device; the obtaining device; the content information generating device; and the reproducing device. According to the information reproducing method, it is provided with: the first judging process; the obtaining process; the content information generating process; and the reproducing process. Therefore, while the copyright of the content is protected, a user can watch the content information, preferably.

### BRIEF DESCRIPTION OF THE DRAWINGS

FIG. 1 is a block diagram conceptually showing the basic structure of an embodiment according to an information recording/reproducing apparatus of the present invention;

FIG. 2 is a flowchart conceptually showing a flow of MOVE processing of the information recording/reproducing apparatus in the embodiment;

FIG. 3 is a data structural view conceptually showing identifier information which is used on the information recording/reproducing apparatus in the embodiment;

FIG. 4 is a data structural view conceptually showing history information which is used on the information recording/reproducing apparatus in the embodiment;

FIG. 5 is a block diagram in which constituent elements about the MOVE processing are extracted from the constituent elements of the information recording/reproducing apparatus in the embodiment;

FIG. 6A to FIG. 6D are explanatory diagrams conceptually showing data which is recorded on each of a hard disk and an optical disc at the time of MOVE processing.

FIG. 7 is a flowchart conceptually showing a flow of reproduction processing of reproducing HD content after the MOVE processing of the information recording/reproducing apparatus in the embodiment;

FIG. 8 is a block diagram in which constituent elements about the reproduction processing of HD content after the MOVE processing are extracted from the constituent elements of the information recording/reproducing apparatus in the embodiment;

FIG. 9 is an explanatory diagram showing one specific example of a window screen for confirming a user about whether or not to delete scramble data;

FIG. 10 is a flowchart conceptually showing a flow of delete processing of the scramble data or the like, on the information recording/reproducing apparatus in the embodiment;

FIG. 11 is an explanatory diagram showing one specific example of a window screen for letting a user select SD content to be deleted;

FIG. 12 is an explanatory diagram showing one specific example of a window screen for letting a user select scramble data to be deleted;

FIG. 13 is an explanatory diagram showing one specific example of a window screen for confirming a user about whether or not to delete scramble data; and

FIG. 14A and FIG. 14B are data structural views conceptually showing the data structures on a hard disk of normal HD content and scramble data, respectively.

### DETAILED DESCRIPTION OF THE PREFERRED EMBODIMENT

The embodiment of the present invention will be explained with reference to the drawings.

(Basic Structure)

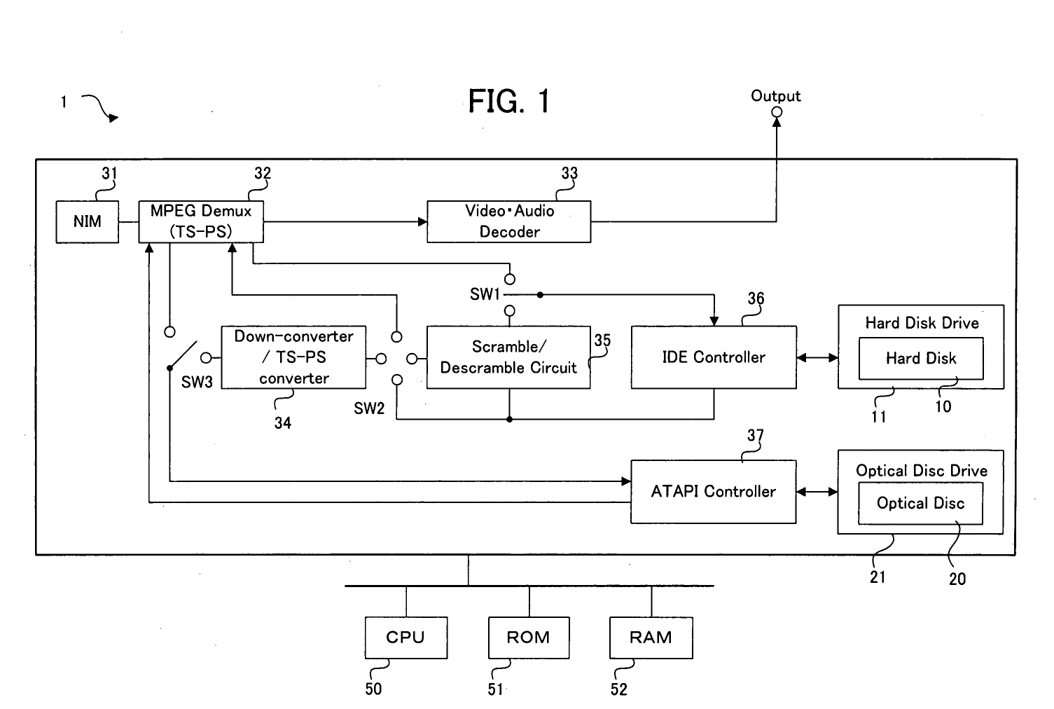

At first, with reference to FIG. 1, the basic structure of an embodiment of an information recording/reproducing apparatus (an information recording apparatus or an information reproducing apparatus) of the present invention will be explained. FIG. 1 is a block diagram conceptually showing the basic structure of the information recording/reproducing apparatus in the embodiment.

As shown in FIG. 1, an information recording/reproducing apparatus 1 is constructed to record data onto a hard disk 10 and an optical disc 20. The information recording/reproducing apparatus 1 is provided with: a hard disk drive 11; an optical disc drive 21; a Network Interface Module (NIM) 31; a MPEG Demux 32; a video/audio decoder 33; a down-converter/Transport Stream-Program Stream (TS-PS) converter 34; a scramble/descramble circuit 35; an Integrated Drive Electronics (IDE) controller 36; an AT Attachment Packet Interface (ATAPI) controller 37; a SW1; a SW2; a SW3; a CPU 50; a RAM 51; and a ROM 52.

The hard disk 10 is one specific example of the “first recording medium” of the present invention, and is a magnetic recording medium on which various data can be recorded. In particular, the hard disk 10 has a larger recording capacity than that of the optical disc 20.

The hard disk drive 11 is one specific example of the “second recoding device” or the “deleting device” of the present invention, and can record or delete various data on the hard disk 10.

The optical disc 20 is one specific example of the “second recording medium” of the present invention, and is a disc-shaped information recording medium with a diameter of 12 cm, as is a DVD, for example.

In particular, the optical disc 20, which is used on the information recording/reproducing apparatus 1 according to the embodiment, is a writable optical disc compatible with the CPRM (e.g. a DVD-RW or the like).

The optical disc drive 21 is one specific example of the “first recording device” of the present invention, and can record or delete various data on the optical disc 20.

The NIM (Network Interface Module) 31 performs frequency tuning to receive a MPEG-TS (Transport Stream), such as a TV program and a movie program broadcasted. Moreover, the NIM 31 can select the MPEG-TS to be received (or select a channel). Then, the NIM 31 can output the received MPEG-TS to the MPEG Demux 32.

The MPEG Demux 32 can extract video packets and audio packets (and moreover, sub-picture packets or the like), from the MPEG-TS (Transport Stream) and a MPEG-PS (Program Stream), and can output them to the video/audio decoder 33.

The video/audio decoder 33 can decode the video packets and the audio packets or the like outputted from the MPEG Demux 32. Then, the decoded data is outputted to an output terminal, to thereby display a video on a display which is connected to the output terminal and to output an audio on a speaker.

The down-converter/TS-PS (Transport Stream-Program Stream) converter 34 is one specific example of the “down-convert device” of the present invention. The down-converter/TS-PS converter 34 can convert data related to a video of the HD size (1920 pixel×1080 pixel) to data related to a video of the SD size (720 pixel×480 pixel). Alternatively, the down-converter/TS-PS converter 34 can convert the data related to a video of the SD size to the data related to a video of the HD size. Moreover, in addition to this conversion processing of the pixel size, the down-converter/TS-PS converter 34 performs the TS-PS format conversion of the data which is inputted.

Incidentally, in the embodiment, in the case that a video is distinguished merely from the number of pixels, the video is distinguished in the name of the HD size video and the SD size video. Then, a video which has the number of pixels corresponding to the HD size video and which actually realizes the HD image quality is particularly distinguished in the name of HD content. Moreover, a video having the number of pixels corresponding to the SD size video cannot realize the HD image quality, and the video may be referred to as SD content in some cases.

The scramble/descramble circuit 35 scrambles a HD stream read from the hard disk 10, on the basis of a predetermined scramble key. As a result, the scramble/descramble circuit 35 can generate scramble data. The generated scramble data is recorded onto the hard disk 10. Moreover, the scramble/descramble circuit 35 descrambles the scramble data read from the hard disk 10, on the basis of the predetermined scramble key. Namely, in descrambling, the inverse data processing of the above-mentioned scramble processing is performed with respect to the scramble data. As a result, the scramble/descramble circuit 35 can generate HD content. Then, a circuit portion which performs the scramble processing corresponds to one specific example of the “scramble device” of the present invention, and a circuit portion which performs the descramble processing corresponds to one specific example of the “content information generating device” of the present invention. Incidentally, the scramble/descramble circuit 35 may be divided into two circuits, which are a scramble circuit and a descramble circuit.

The IDE (Integrated Drive Electronics) controller 36 can control the hard disk drive 11, and particularly, it can control the recording or reproduction of various data on the hard disk 10. Moreover, the IDE controller 36 may be able to generate an encryption key required for encryption (i.e. Local Encryption), in recording the data onto the hard disk 10.

The ATAPI (AT Attachment Packet Interface) controller 37 can control the optical disc drive 21, and particularly, it can control the recording or reproduction of various data on the optical disc 20. Moreover, the ATAPI controller 37 encrypts the various data or decrypts the encrypted various data, in accordance with the standard of CPRM or the like, in recording or reproducing the various data.

The SW1 can shift an input to the IDE controller 36, depending on which data out of the data outputted from the MPEG Demux 32 (e.g. the HD content or the like) and the data outputted from the scramble/descramble circuit 35 (e.g. the scramble data or the like) is recorded onto the hard disk 10.

The SW2 can shift an input to the MPEG Demux 32 or the down-converter/TS-PS converter 34, , depending on whether the data outputted from the IDE controller 36 (i.e. the hard disk 10) is inputted to the MPEG Demux 32 or the down-converter/TS-PS converter 34, or the data outputted from the scramble/descramble circuit 35 is inputted to the MPEG Demux 32 or the down-converter/TS-PS converter 34.

The SW3 can shift an input to the ATAPI controller 37, depending on which data out of the data outputted from the MPEG Demux 32 (e.g. the SD content or the like) and the data outputted from the down-converter/TS-PS converter 34 (e.g. the SD content or the like) is recorded onto the optical disc 20.

The CPU 50 can control the processing (i.e. operation) of the whole information recording/reproducing apparatus 1 (i.e. various constituent elements surrounded by a solid line in FIG. 1). Namely, the CPU 50 controls the processing of the whole information recording/reproducing apparatus 1 by outputting a system command to each of the constituent elements provided for the information recording/reproducing apparatus 1.

The RAM 51 can temporarily record therein various data required for the processing of the information recording/reproducing apparatus 1.

The ROM 52 can record therein software for operating the CPU 50.

Incidentally, out of the various constituent elements of the information recording/reproducing apparatus 1, the hard disk drive 11, the optical disc drive 21, the down-converter/TS-PS converter 34, the scramble/descramble circuit 35, the IDE controller 36, the ATAPI controller 37 or the like in FIG. 1 mainly constitute one specific example of the information recording apparatus of the present invention. Moreover, the hard disk drive 11, the optical disc drive 21, the MPEG Demux 32, the video/audio decoder 33, the scramble/descramble circuit 35, the IDE controller 36, the ATAPI controller 37 or the like in FIG. 1 mainly constitute one specific example of the information reproducing apparatus of the present invention.

Moreover, arrows appended to data-buses, which connect the various constituent elements, indicate the input/output direction of data, illustratively. It is obvious that the input/output direction of data is not limited to the direction of the arrows which are shown in FIG. 1.

(Processing Principle)

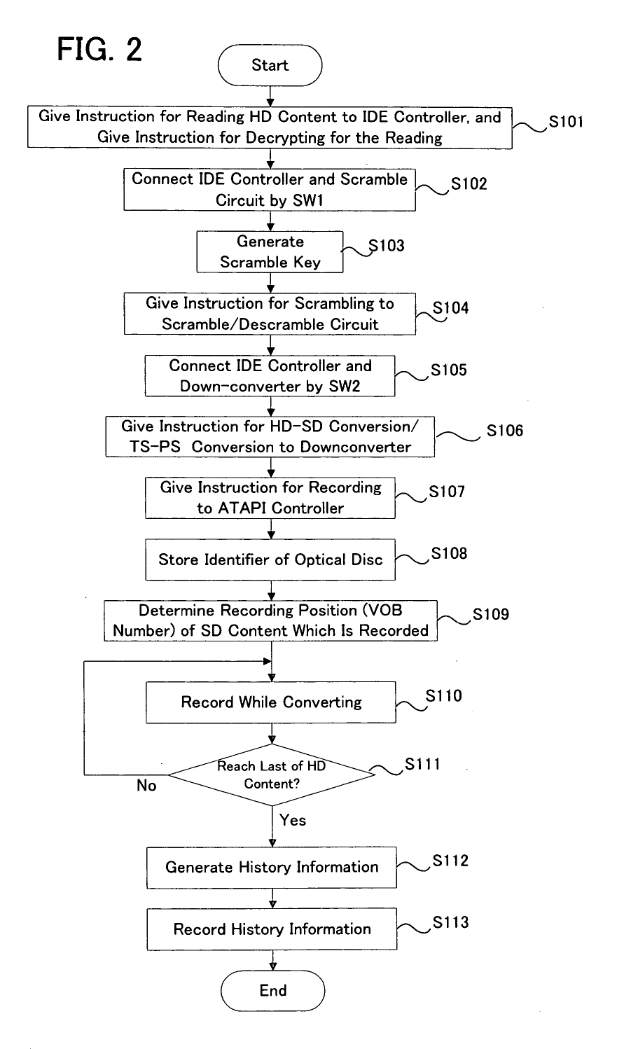

Next, with reference to FIG. 2 to FIG. 8, the processing principle of the information recording/reproducing apparatus in the embodiment will be explained.

(1) MOVE Processing

At first, with reference to FIG. 2, the MOVE processing of the information recording/reproducing apparatus in the embodiment will be explained. FIG. 2 is a flowchart conceptually showing a flow of the MOVE processing.

Incidentally, as the assumption of the MOVE processing, the processing in the case where HD content is recorded onto the hard disk 10 will be briefly explained. At first, a MPEG transport stream or the like which is broadcasted by a ground electric wave or a satellite electric wave or which is distributed through a communication network is received on the NIM 31. From the received MPEG transport stream or the like, video packets and audio packets constituting a desired program are extracted on the MPEG Demux 32, and outputted to the IDE controller 36. At this time, under the control of the CPU 50, the SW1 is shifted to the MPEG Demux 32 side, to thereby connect the MPEG Demux 32 and the IDE controller 36. Then, by the processing of the IDE controller 36, the video packets and the audio packets constituting the desired program are recorded onto the hard disk 10. At this time, the HD content is locally encrypted and then recorded, under the control of the IDE controller 36.

Next, the MOVE processing will be explained. Incidentally, the explanation below will proceed under the assumption that the HD content received on the NIM 31 is recorded on the hard disk 10 at this time.

As shown in FIG. 2, a system command which indicates an instruction for reading the HD content is outputted from the CPU 50 to the IDE controller 36 (step S101). By this, the HD content recorded on the hard disk 10 is read. At this time, the HD content is recorded on the encrypted hard disk 10, so that decryption processing is performed with the reading of the HD content.

Then, under the control of the CPU 50, the SW1 is shifted to the scramble/descramble circuit 35 side. By this, the IDE controller 36 and the scramble/descramble circuit 35 are connected (step S102). Then, the HD content read from the hard disk 10 is outputted from the IDE controller 36 to the scramble/descramble circuit 35.

Then, by the processing of the CPU 50 which is one specific example of the “key generating device” of the present invention, a scramble key for scrambling the HD content is generated (step S103).

Now, the scramble key will be explained, specifically. The scramble key is used for the scramble processing of the HD content, and can be set arbitrarily by the CPU 50. The scramble key preferably is highly confidential and indecipherable, in order to prevent a third party from easily descrambling the scramble data generated by the scramble processing.

The scramble key may be generated on the basis of the SD content recorded onto the optical disc 20. For example, the data of the SD content (e.g. data in each frame) corresponding to the reproduction time point (i.e. at the same reproduction time point) of the HD content which is inputted to the scramble/descramble circuit 35 may be regarded as the scramble key. Alternatively, at least one portion of the SD content may be regarded as the scramble key. Then, the scramble processing may be performed by repeatedly using the scramble key which has a smaller data size than that of the HD content. At this time, the SD content (or one portion thereof) is used as the scramble key, so that it is necessary to use the optical disc 20 on which the SD content is actually and properly recorded, in the descramble processing, as described later. Therefore, as in the embodiment, if the copyright of the optical disc 20 (particularly, the content recorded on the optical disc 20) is protected by the CPRM (e.g. if the content cannot be read easily), then, it is possible to prevent the duplication or copying of the scramble key (particularly, illegal copying), more effectively.

Moreover, an encryption key for encryption based on the CPRM may be used as the scramble key. Alternatively, the scramble key may be generated on the basis of the encryption key. Moreover, the scramble key may be generated on the basis of various information required for the generation of this encryption key. By this, it is possible to prevent the duplication or copying of the scramble key (particularly, illegal copying), more effectively.

Alternatively, the scramble key may be generated on the basis of peculiar information (e.g. a disc key, a media ID, other various identification numbers, etc.) to the optical disc 20 onto which the SD content is recorded. By this, in order to generate the scramble key, the optical disc 20 on which the SD content is actually and properly recorded is necessary, so that it is possible to prevent the duplication or copying of the scramble key (particularly, illegal copying), more effectively.

In other words, in order not to easily be duplicated or copied the scramble key (i.e. in order not to easily be descrambled the scramble data), it is preferable to generate a SD stream or a scramble key peculiar to the optical disc 20 onto which the SD stream is actually and properly recorded. By this, even if someone illegally obtains the scramble data, the person cannot easily duplicate or copy the scramble key. Thus, the person eventually cannot descramble it as the HD stream. Thus, it is possible to preferably protect the copyright of the content.

For reference, in a Secure Socket Layer (SSL) which is used for the encryption of the data in the data transmission/reception on a network, encryption processing is performed by using a key of a 128 bit size. In the embodiment, however, it is preferable to perform the scramble processing by using a scramble key having the number of bits larger than 128 bits, in order to protect the copyright of the content, more preferably. For example, as described above, the scramble processing may be performed by using a scramble key of a size corresponding to the data amount of 1 frame.

Then, a system command which indicates an instruction for scrambling the HD content is outputted from the CPU 50 to the scramble/descramble circuit 35 (step S104). By this, the HD content recorded on the hard disk 10 is scrambled on the basis of the scramble key generated at the step S103, and thereby the scramble data is generated. This scramble data is recorded onto the hard disk 10, as occasion demands. At this time, the scramble data may be locally encrypted and then recorded onto the hard disk 10.

Incidentally, the scramble/descramble circuit 35 may perform the logical processing, such as an exclusive OR, of the scramble key and the data related to the HD content, to thereby generate the scramble data. Namely, the scramble key may be used as a conversion factor, and the exclusive OR processing may be adopted as a conversion format. Alternatively, the scramble/descramble circuit 35 may perform a predetermined processing (e.g. a shift processing), with respect to the data related to the HD content, to thereby generate the scramble data. Alternatively, the scramble/descramble circuit 35 may perform other processing with respect to the data related to the HD content, to thereby generate the scramble data. In short, it is enough to generate the scramble data which itself does not mean a predetermined video and audio or the like and which constitutes a meaningful video and audio or the like only after the data processing (specifically, the descramble processing) together with the scramble key. Namely, the “scramble processing” in the present invention indicates converting the data which indicates a predetermined video or the like to the data which itself cannot indicates the predetermined video or the like.

Then, the SW2 is shifted under the control of the CPU 50, to thereby connect the IDE controller 36 and the down-converter/TS-PS converter 34 (step S105). Then, the HD content read from the hard disk 10 is outputted from the IDE controller 36 to the down-converter/TS-PS converter 34.

Then, a system command which indicates an instruction for down-converting or TS-PS converting the HD content is outputted from the CPU 50 to the down-converter/TS-PS converter 34 (step S106). Therefore, the HD content outputted from the hard disk 10 is down-converted to SD content, and the HD content in a transport stream format is converted to the SD content in a program stream format. In the embodiment, however, the down-converting and the TS-PS converting are actually started after storing the identifier of the optical disc 20 and specifying a recording position where the SD content is to be recorded on the optical disc 20, as explained later.

Then, a system command which indicates an instruction for recording the SD content outputted from the down-converter/TS-PS converter 34 onto the optical disc 20 is outputted from the CPU 50 to the ATAPI controller 37 (step S107). By this, the ATAPI controller 37 records the SD content onto the optical disc 20. At this time, the SD content is recorded onto the optical disc 20 after encrypted on the basis of the CPRM. In the embodiment, however, the recording of the SD content is actually started after storing the identifier of the optical disc 20 and specifying a recording position where the SD content is to be recorded on the optical disc 20, as explained later.

Before the recording of the SD content, the identifier of the optical disc 20 onto which the SD content will be recorded is read, under the control of the CPU 50. The read identifier is recorded onto the hard disk 10 which is also one specific example of the “identifier storing device” of the present invention, for example. The read identifier may be stored into another recording medium, such as the RAM 51, for example.

This identifier may be a media ID which is recorded in a bar code shape in a Narrow Burst Cutting Area (NBCA) in the case of a DVD which is one specific example of the optical disc 20, for example. Alternatively, the identifier may be another disc ID. Alternatively, these IDs may be combined to make one identifier. Namely, information, which can uniquely specify the optical disc 20 on which the SD content is recorded from among an enormous number of optical discs 20, can be used as the identifier in the embodiment.

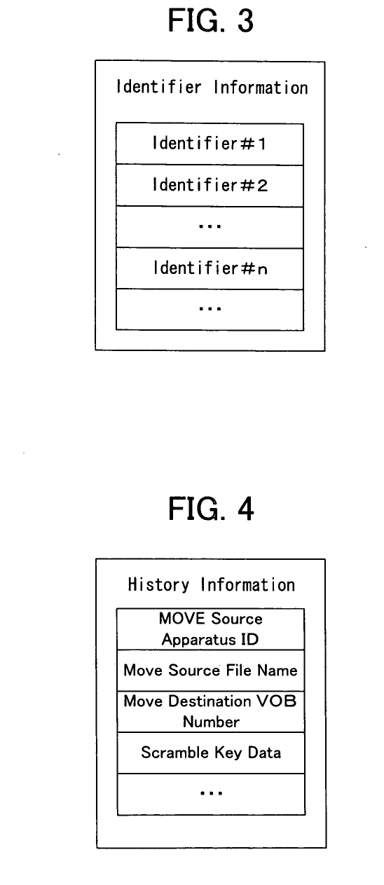

Now, storing processing of the identifier of the optical disc 20 will be explained in more detail, with reference to FIG. 3. FIG. 3 is a data structural view conceptually showing the identifier which is recorded on the hard disk 10 or the like.

As shown in FIG. 3, the identifier of the optical disc 20 onto which the SD content will be recorded is recorded on the hard disk 10, as identifier information. Here, it is preferable that the identifier of the optical disc 20 on which the content is recorded by the information recording/reproducing apparatus 1 be stored as the identifier information in a form of list (or table). For example, as for the identifier information shown in FIG. 3, the information recording/reproducing apparatus 1 records one HD content which is down-converted (i.e. one SD content) on the optical disc 20 specified by an identifier #1, records another HD content which is down-converted (i.e. another SD content) onto the optical disc 20 specified by an identifier #2, and records another HD content which is down-converted (i.e. another SD content) onto the optical disc 20 specified by an identifier #3.

Again in FIG. 2, under the control of the CPU 50, a recording position where the SD content is recorded on the optical disc 20 is specified (step S109). This recording position may be a VOB number of an address position where the SD content is recorded in the case of a DVD which is one specific example of the optical disc 20, for example. Alternatively, this recording position may be other various information as long as the other various information can specify a recording position where the SD content is actually recorded.

Then, under the control of the CPU 50, the SD content outputted from the down-converter/TS-PS converter 34 is recorded onto the optical disc 20 while the down-converting and the TS-PS converting of the HD content are actually performed (step S110). More specifically, CPRM processing is performed with respect to the SD content. Specifically, an encryption key is generated in accordance with a device key owned by the information recording/reproducing apparatus 1 and a media key recorded in advance on the optical disc 20 (e.g. MKB (Media Key Block)) or the like. Then, on the basis of this encryption key, the content which will be recorded (which is the SD content in this case) is encrypted. Then, the encrypted SD content is recorded onto the optical disc 20. At this time, in order to satisfy the requirements of the MOVE processing, the HD content recorded on the hard disk 10 is deleted at the same time of or in parallel with the recording of the SD content.

Then, it is judged whether or not the last part of the HD content is down-converted or the like (i.e. whether or not to reach the last part of the HD content) (step S111). Namely, it is judged whether or not the SD content corresponding to the last part of the HD content is recorded onto the optical disc 20.

As a result of this judgment, if it is judged that the last part of the HD content is not down-converted or the like yet (the step S111: No), the operational flow returns to the step S110 again, and the down-converting or the like of the HD content and the recording of the SD content onto the optical disc 20 (and moreover, the deletion of the HD content recorded on the hard disk 10) are continued. On the other hand, if it is judged that the last part of the HD content is down-converted or the like (the step S111: Yes), history information is generated under the control of the CPU 50 which is one specific example of the “history information generating device” of the present invention (step S112).

This history information will be explained in more detail with reference to FIG. 4. FIG. 4 is a data structural view conceptually showing the history information.

As shown in FIG. 4, the history information indicates a history about each of the MOVE processing and the scramble processing. For example, the history information includes: information for uniquely showing a relationship between the information recording/reproducing apparatus which performs the MOVE processing and the optical disc on which the content is recorded by the MOVE processing; the scramble key used for the scramble processing; information for indicating the scramble data generated as a result of the scramble processing; and the like. More specifically, the history information includes (i) a MOVE source apparatus ID, (ii) a MOVE source file name, (iii) a MOVE destination VOB number, and (iv) scramble key data.

The MOVE source apparatus ID is an identification number or the like for specifying the information recording/reproducing apparatus which actually performs the MOVE processing. For example, it may be an apparatus ID (device ID) which is assigned to each information recording/reproducing apparatus. Alternatively, the MOVE source apparatus ID may be other information, as long as the other information can uniquely specify the information recording/reproducing apparatus which actually performs the MOVE processing.

The MOVE source file name is information for specifying the HD content which is the object of the MOVE processing. For example, it is the file name of the moved HD content in the information recording/reproducing apparatus (or a title name, a program name, or the like).

The MOVE destination VOB number is information for specifying a recording position on the optical disc 20 of the SD content which is recorded as a result of the MOVE processing. For example, in the case of a DVD as being one specific example of the optical disc 20, it indicates a VOB number, for example.

The scramble key data is information for specifying the scramble key used at the time of generation of the scramble data. For example, the scramble key data may be information for indicating the scramble key itself. Alternatively, the scramble key data may be information which alone does not indicate the scramble key but which indicates the scramble key itself after a predetermined processing being performed with respect to the scramble key data. Moreover, the scramble key data may include information for indicating the conversion format (e.g. the method, the type, or the like of a processing, and specifically an XOR processing, a shift processing, or the like) used in the scramble processing.

Incidentally, it is not necessary for the history information to include the whole of the information described above. The history information may include a part of the information described above. Moreover, the history information may include various information other than the above-mentioned information. In short, information which indicates the history about each for the MOVE processing and the scramble processing and which can ensure another reproduction processing (or second-time reproduction operation) of the once down-converted HD content is included in a range of the history information in the embodiment.

Again in FIG. 2, the history information generated at the step S112 is recorded onto the optical disc 20 (step S113). At this time, a plurality of types (i.e. a plurality of titles) of SD contents may be recorded on the optical disc 20. Therefore, it is preferable to record the history information onto the optical disc 20 with associating the recorded SD content with the history information related to the recording of the SD content (i.e. the MOVE processing). For example, the file name of the moved HD content (i.e. the file name of the SD content which is generated by down-converting the HD content in the optical disc 20) may be included in the history information, to thereby associate the history information with the SD content. Alternatively, the “MOVE destination VOB number” included in the history information may be used, to thereby associate the history information with the SD content.

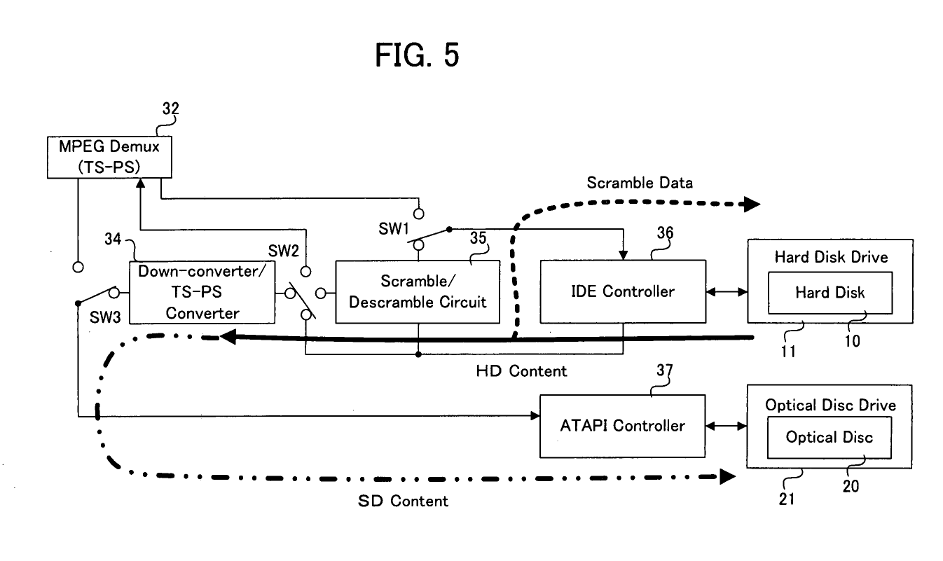

The constituent elements and the flow of data in a block diagram in actually performing the MOVE processing will be explained with reference to FIG .5. FIG. 5 is a block diagram in which the constituent elements about the MOVE processing are extracted.

As shown in FIG. 5, the above-mentioned MOVE processing is performed mainly by the processing of the hard disk drive 11, the optical disc drive 21, the down-converter/TS-PS converter 34, the scramble/descramble circuit 35, the IDE controller 36, the ATAPI controller 37, the SW1, the SW2, and the SW3 and the like. Then, as the flow of data is shown in a thick line, the HD content is outputted to the scramble/descramble circuit 35 and the down-converter/TS-PS converter 34 through the IDE controller 36. Moreover, as the flow of data is shown in a dashed line, the scramble data is outputted from the scramble/descramble circuit 35 to the IDE controller 36, and is recorded onto the hard disk 10. Moreover, as the flow of data is shown in a two-dot chain line, the SD content is outputted from the down-converter/TS-PS converter 34 to the ATAPI controller 37, and is recorded onto the optical disc 20.

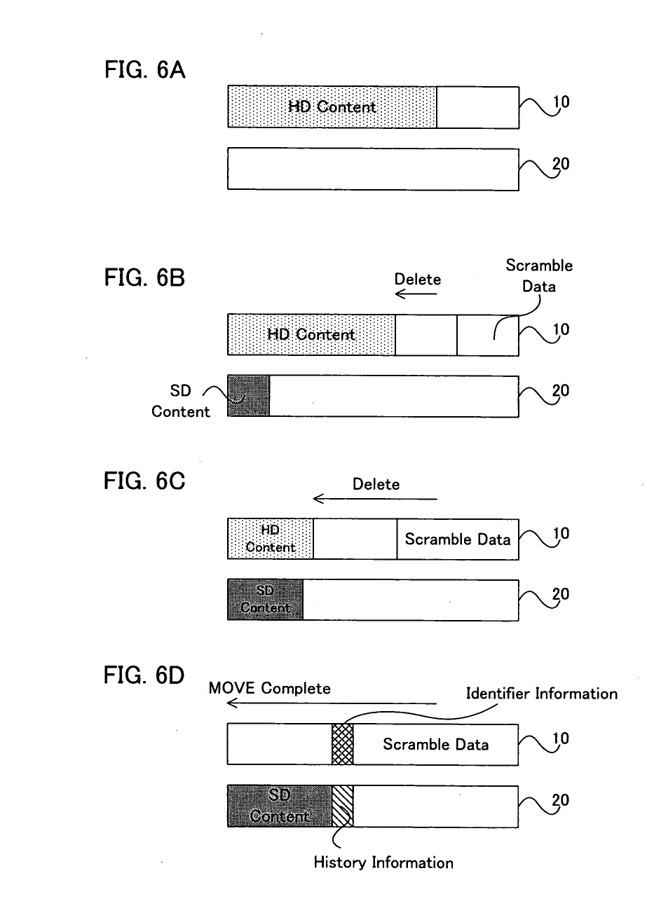

The above-described explanation is summarized as follows. The SD stream is recorded onto the optical disc 20. At the same time, the HD stream is deleted from the hard disk 10, and the scramble data is recorded onto the hard disk 10. The aspect of the data which is recorded on each of the hard disk 10 and the optical disc 20 at this time will be explained with reference to FIG. 6A to FIG. 6D. FIG. 6A to FIG. 6D are explanatory diagrams conceptually showing data which is recorded on each of the hard disk 10 and the optical disc 20 at the time of MOVE processing.

As shown in FIG. 6A, before the MOVE processing, the whole HD content is recorded on the hard disk 10.

Then, as the above-mentioned MOVE processing proceeds, as shown in FIG. 6B and FIG. 6C, the HD content is gradually deleted from the hard disk 10. Moreover, the scramble data is gradually recorded onto the hard disk 10. Moreover, the SD content is gradually recorded onto the optical disc 20.

When the whole SD content is recorded on the optical disc 20, as shown in FIG. 6D, the whole HD content is deleted from the hard disk 10, and instead, the scramble data is recorded. Moreover, the identifier information is recorded on the hard disk 10, and the history information is recorded on the optical disc 20.

Incidentally, it is preferable to perform the MOVE processing so as to delete a portion of the HD content corresponding to a portion of the SD content which is currently recorded onto the optical disc 20 in accordance with the recording timing of the SD content. In other words, it is preferable to perform the MOVE processing so as to delete the HD content which indicates a video corresponding to a video indicated by the SD contents currently recorded on the optical disc 20 (i.e. the HD content in the same frame or at the same reproduction time point), from the hard disk 10 in accordance with the recording timing of the SD content. For example, the SD content is preferably recorded onto the optical disc 20 by a unit of reproduction time of 1 minute (or several minutes or several seconds), and the HD content is preferably deleted from the hard disk 10 corresponding to the SD content which is currently recorded. Incidentally, the aspect (i.e. the timing, order or the like) of the recording of the SD content and the aspect of the deleting of the HD content are not limited the aspect as described above. As long as the copyright of the content is properly protected when a user uses the optical disc 20 and the hard disk 10, it is possible to record the SD content and the scramble data and delete the HD content, in an arbitrary order and aspect.

As described above, according to the information recording/reproducing apparatus 1 in the embodiment, it is possible to protect the copyright of the content, properly. In particular, by recording the identifier (the identifier information) onto the hard disk 10 and by recording the history information onto the optical disc 20, it is possible to protect the copyright of the content, more properly, as explained in a reproduction operation hereinafter.

Incidentally, in the above-mentioned embodiment, the SD content is recorded after the generation of the scramble data. However, the recording of the SD content and the generation of the scramble data may be performed at the same time or in parallel. In this case, in deleting the HD content, the generated scramble data may be overwritten into a recording area where the HD content is recorded, which means the deletion of the HD content. Moreover, the scramble data may be generated after the recording of the SD content. In short, as long as the scramble data and the identifier information are recorded on the hard disk 10, the HD content is deleted and the SD content and the history information are recorded on the optical disc 20 in the end, it is possible to perform the MOVE processing in an arbitrary order and format. However, it is more preferable to perform the MOVE processing in accordance with a standard which defines the MOVE processing.

(2) Reproduction Processing of Reproducing HD Content After MOVE Processing

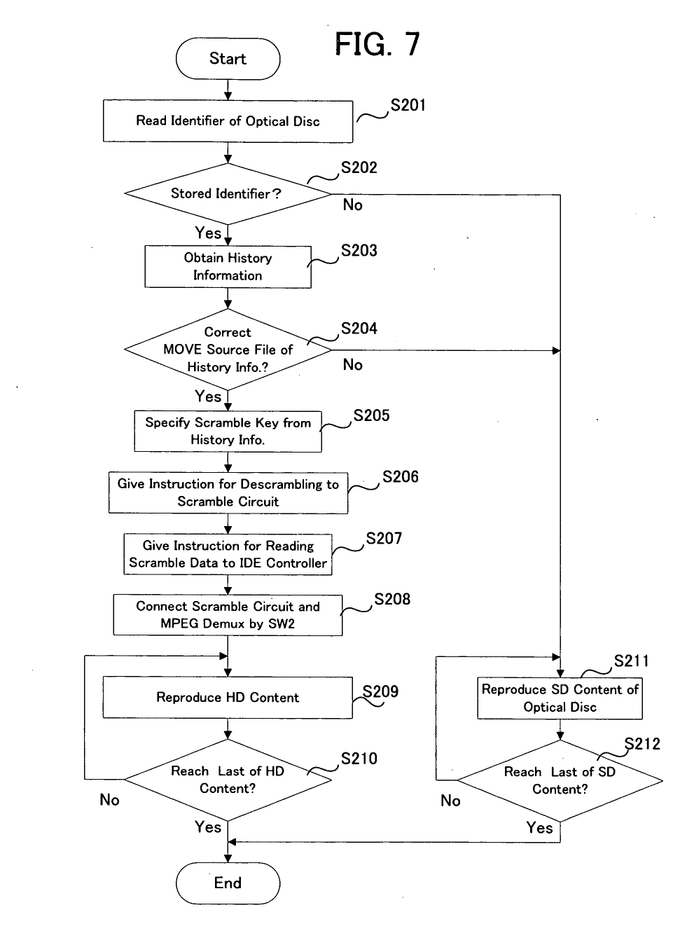

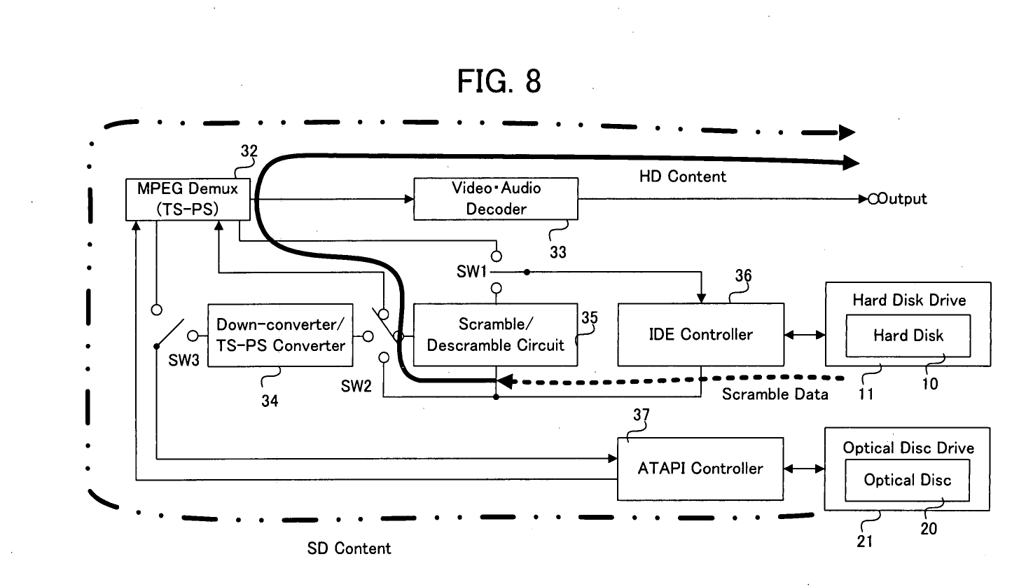

Next, with reference to FIG. 7 and FIG. 8, the reproduction processing of reproducing a HD image quality video after the MOVE processing will be explained. FIG. 7 is a flowchart conceptually showing a flow of the reproduction processing of reproducing the HD content after the MOVE processing. FIG. 8 is a block diagram in which constituent elements about the reproduction processing of reproducing HD content after the MOVE processing are extracted.

As shown in FIG. 7, at first, the optical disc 20 which is the reproduction object is loaded onto the information recording/reproducing apparatus 1, and the identifier of the optical disc 20 is read (step S201). Then, it is judged whether or not the identifier read at the step S201 is included in the identifier information stored in the hard disk 10 (step S202). Namely, by the processing of this information recording/reproducing apparatus 1 which actually loads the optical disc 20, it is judged whether or not the SD content is recorded onto this loaded optical disc 20.

As a result of this judgment, if it is judged that the identifier read in the step S201 is not included in the identifier information stored in the hard disk 10 (the step S202: No), it is impossible to perform the reproduction processing of the HD content (more specifically, the reproduction processing of the HD content which uses the scramble data). Namely, even if the optical disc 20 on which the history information and the SD content are illegally copied is loaded onto the information recording/reproducing apparatus 1, the identifier of the optical disc 20 is not stored on the information recording/reproducing apparatus 1. Thus, it is impossible to perform the reproduction processing of the HD content corresponding to the SD content recorded on the optical disc 20 (i.e. the scramble processing of the scramble data), by using the history information illegally copied on the optical disc 20.

In this case, however, it is possible to reproduce the SD content or the like recorded on the optical disc 20 (step S211). Therefore, if the HD content is recorded on the optical disc 20, the HD content can be reproduced. Incidentally, the reproduction of the SD content or the like recorded on the optical disc 20 will be explained in detail later.

On the other hand, if it is judged that the identifier read at the step S201 is included in the identifier information stored in the hard disk 10 (the step S202: Yes), the history information recorded on the optical disc 20 is obtained (step S203). Then, it is judged whether or not the MOVE source file name in the history information obtained at the step S203 is correct (step S204). More specifically, it is judged whether or not the MOVE source file name in the history information coincides with the file name of the HD content which is the object of the MOVE processing by the information recording/reproducing apparatus 1. For example, if the information recording/reproducing apparatus 1 stores therein the file name of the HD content which is the object of the MOVE processing, the above-mentioned judgment may be performed by comparing the stored file name with the MOVE source file name of the history information. Alternatively, if the scramble data associated with the file name of the original HD content is recorded, the above-mentioned judgment may be performed by comparing the associated file name with the MOVE source file name of the history information. If these file names coincide, it is judged that the MOVE source file name is correct. On the other hand, if these file names do not coincide, it is judged that the MOVE source file name is wrong.

As a result of this judgment, if it is judged that the MOVE source file name is wrong (the step S204: No), it is impossible to perform the reproduction operation of the HD content corresponding to the SD content recorded on the optical disc 20 (more specifically, the reproduction processing of the HD content which uses the scramble data). In this case, however, it is possible to reproduce the SD content of the like recorded on the optical disc 20 (step S211).

On the other hand, if it is judged that the MOVE source file name is correct (the step S204: Yes), the scramble key data is obtained from the history information and the scramble key is specified, under the control of the CPU 50 (step S205). By this, the same scramble key as the scramble key used in the above-mentioned scramble processing is specified. In addition, the conversion format used in the above-mentioned scramble processing may be specified. Then, this specified scramble key or the like is outputted to the scramble/descramble circuit 35.

Incidentally, it is preferable to judge whether or not the MOVE source apparatus ID in the history information obtained at the step S203 coincides with the apparatus ID of the information recording/reproducing apparatus 1, at the same time of or in parallel with the judgment of the MOVE source file name at the step S204. As a result of this judgment, if they don't coincide, it is preferable not to perform the reproduction processing of the HD content corresponding to the SD content recorded on the loaded optical disc 20. Thus, only the information recording/reproducing apparatus 1 which actually and properly performs the MOVE processing with respect to the loaded optical disc 20 can reproduce the HD content corresponding to the SD content recorded on the optical disc 20 (i.e. the descramble processing of the scramble data). Therefore, another information recording/reproducing apparatus which does not perform the MOVE operation cannot reproduce the HD content, which is how to protect the copyright of the content, substantially.

Moreover, it is preferable to judge whether or not the MOVE destination VOB number of the history information obtained at the step S203 coincides with the VOB number of the SD content or the like actually and properly recorded on the optical disc 20, at the same time of or in parallel with the judgment in the step S204. As a result of this judgment, if they don't coincide, it is preferable not to perform the reproduction processing of the HD content corresponding to the SD content recorded on the loaded optical disc 20. Thus, if the VOB number of the recording area where the SD content is recorded is changed by illegally copying the SD content and the history information, it is impossible to reproduce the HD content corresponding to the SD content (i.e. the descramble processing of the scramble data). Therefore, if the optical disc which is the object of the MOVE processing is not loaded, it is impossible to reproduce the HD content, which is how to protect the copyright of the content, substantially.

Then, a system command which indicates an instruction for descrambling the scramble data is outputted from the CPU 50 to the scramble/descramble circuit 35 (step S206). By this, the scramble data recorded on the hard disk 10 is descrambled on the basis of the scramble key specified in the step S205, to thereby generate the HD content. In the embodiment, however, the descrambling processing is actually performed after the shift processing of the SW2, as described below.

Then, a system command which indicates an instruction for reading the scramble data is outputted from the CPU 50 to the IDE controller 36 (step S207). By this, the scramble data recorded on the hard disk 10 is read and outputted to the scramble/descramble circuit 35. At this time, if the scramble data is recorded with encryption, the scramble data is read while being decrypted. In the embodiment, however, the descrambling processing is actually performed after the shift processing of the SW2, as described below.

Then, the SW2 is shifted under the control of the CPU 50, to thereby connect the MPEG Demux 32 and the scramble/descramble circuit 35 (step S208). Then, the HD content which is generated as a result of the descramble processing by the scramble/descramble circuit 35 is outputted to the MPEG Demux 32.

Then, the scramble data is actually read from the hard disk 10, and the read scramble data is descrambled, to thereby reproduce the HD content (step S209). Therefore, a user can watch the HD content.

In the case of an information recording/reproducing apparatus which does not generate the scramble data, as in a conventional hard disk recorder or the like, after the HD content recorded on the hard disk 10 is converted to the SD content and the MOVE processing is performed, it is difficult or impossible to reproduce the relevant SD content as the HD content again. Moreover, if the SD content is up-converted, it is possible to reproduce up-converted SD content as the HD size video, in terms of the number of pixels. However, it is difficult or impossible to reproduce it as the original HD content, in terms of the image quality.

However, according to the information recording/reproducing apparatus 1, even after the HD content recorded on the hard disk 10 is converted to the SD content and it is recorded onto the optical disc 20, if the reproduction processing is performed by using the scramble data, as described above, it is possible to reproduce the HD content again. Even if the HD content is converted to the SD content and it is recorded onto the optical disc 20, only the scramble data which is totally different from the SD content or the original HD content is recorded on the hard disk 10. Thus, the copyright of the content is properly protected.

Therefore, a user can watch a high definition video on a large screen, such as a plasma television or a projector, by reproducing the HD content recorded on a high grade information recording/reproducing apparatus, such as a hard disk recorder, at home or the like. On the other hand, a user can enjoy watching the same content even in an automobile, by using a DVD player equipped for the automobile (or a DVD player in car navigation), by down-converting the HD content and recording it as the SD content onto the optical disc 20, such as a DVD. Namely, even in a place where a high grade AV watching environment can be realized, such as at home, or in a place where a simple AV watching environment can be realized, such as in an automobile, a user can receive such a great benefit of watching a desired content, selectively, in the desired reproduction quality.

In addition, particularly in the embodiment, by referring to the history information and the identifier, it is possible to preferably reproduce the HD content only if the scramble processing and the MOVE processing are properly performed. Thus, it is possible to preferably prevent the illegal reproduction of the illegally copied or duplicated HD content or the like. As a result, it is possible to protect the copyright of the content, more preferably.

Incidentally, in addition to or in place of the reproduction of the HD content as described above, the HD content generated on the scramble/descramble circuit 35 may be recorded onto the hard disk 10 again. Namely, a MOVE BACK processing (HD) may be performed.

Incidentally, the MOVE BACK processing indicates a processing of recording data onto the original recording medium again after the MOVE processing. Specifically, after the MOVE processing in which data, which is recorded on one recording medium, is recorded onto another recording medium, the data recorded on this another recording medium is recorded again onto the one recording medium. This type of processing is referred to as the MOVE BACK processing. In particular, a processing of recording the data onto the original recording medium as the HD content is referred to as a MOVE BACK processing (HD). A processing of recording the data onto the original recording medium as the SD content is referred to as a MOVE BACK processing (SD).

The SD content recorded on the optical disc 20 is deleted in parallel with the recording processing of the HD content (step S208). By this, it is possible to protect the copyright of the content. A user can watch the HD content recorded on the hard disk, again. In this case, the history information, which is related to the MOVE processing of the HD content MOVE BACK-processed, recorded on the optical disc 20 may be also deleted. This is because the history information is not necessary since the HD content is already recorded on the hard disk 10.

At this time, it is preferable to delete the scramble data recorded on the hard disk 10, as well. By this, it is possible to use the recording capacity of the hard disk 10, more effectively.

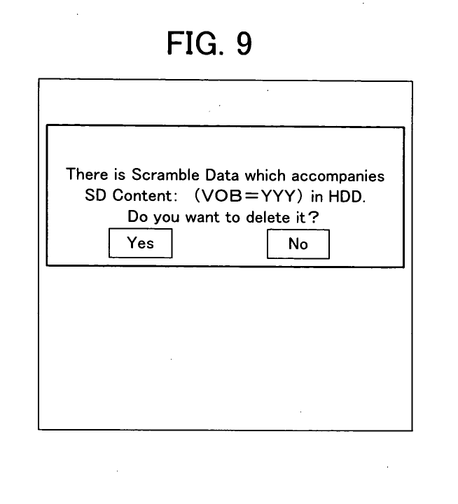

In this case, for example, as shown in FIG. 9, a window screen for confirming the user of the information recording/reproducing apparatus 1 about the delete of the scramble data corresponding to the SD content for which the MOVE BACK processing is performed may be displayed on a display or the like. For example, in FIG. 9, in performing the MOVE BACK processing with respect to the SD content which is specified by a VOB number of “YYY”, it is confirmed whether or not to delete the scramble data which accompanies (i.e. corresponds to) the SD content. If “Yes” is selected by the user, the scramble data is deleted. On the other hand, if “No” is selected by the user, the scramble data is not deleted.

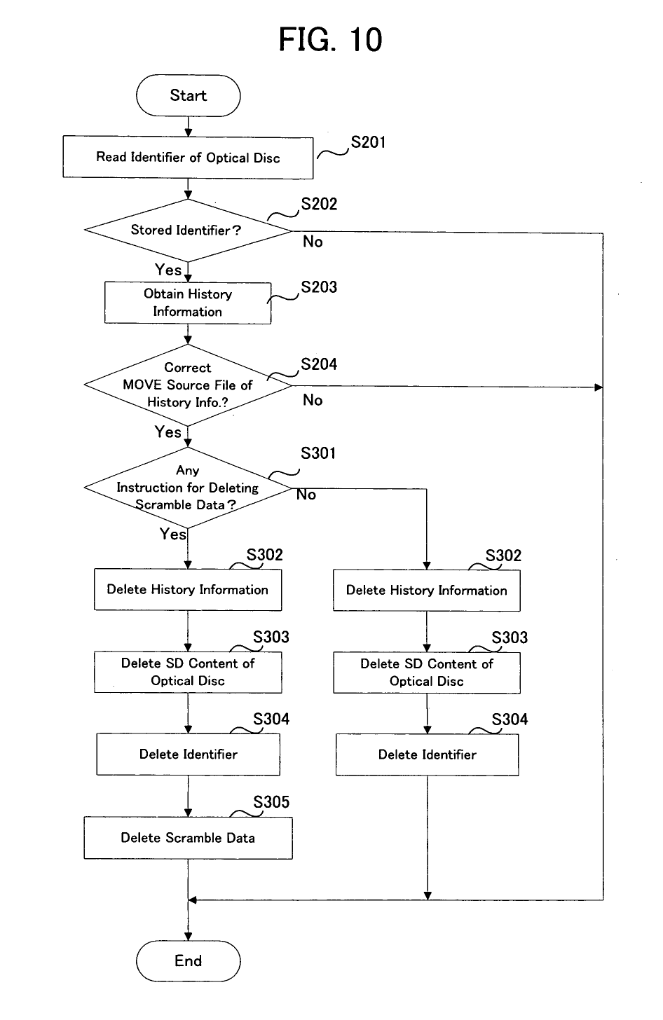

The flow of the delete processing of the scramble data or the like will be explained with reference to the flowchart in FIG. 10. FIG. 10 is a flowchart conceptually showing the flow of delete processing of the scramble data or the like.

As the assumption of the processing shown in FIG. 10, it is assumed that the processing at the steps S201 to S204 in FIG. 7 is already performed, and that it is already confirmed whether or not the proper optical disc 20 (i.e. on which the illegal copying is not performed) is loaded on the information recording/reproducing apparatus 1. Then, it is judged whether or not an instruction for deleting the scramble data is given from a user, by using the screen illustrated in FIG. 9 (step S301).

As a result of this judgment, if it is judged that the instruction for deleting the scramble data is given from the user (the step S301: Yes), the corresponding history information is deleted (step S302), and the SD content on the optical disc 20 is deleted (step S303). Then, the corresponding identifier is deleted from the identifier information (step S304), and the corresponding scramble data is deleted (step S305).

On the other hand, if it is judged that the instruction for deleting the scramble data is not given from the user (the step S301: No), the corresponding history information is deleted (the step S302), and the SD content on the optical disc 20 is deleted (the step S303). Then, the corresponding identifier is deleted from the identifier information (the step S304). The corresponding scramble data is not deleted. In this case, however, the history information which can specify the scramble key for descrambling the scramble data is deleted at the step S302, so that it is impossible to reproduce the HD content from the scramble data. As a result, the copyright of the content is preferably protected.

Incidentally, these processing (i.e. the delete processing of the scramble data) is performed not only in the case where the MOVE BACK processing is performed with respect to the SD content recorded on the optical disc 20, but also in the case where the SD content recorded on the optical disc 20 is deleted by the user's instruction.

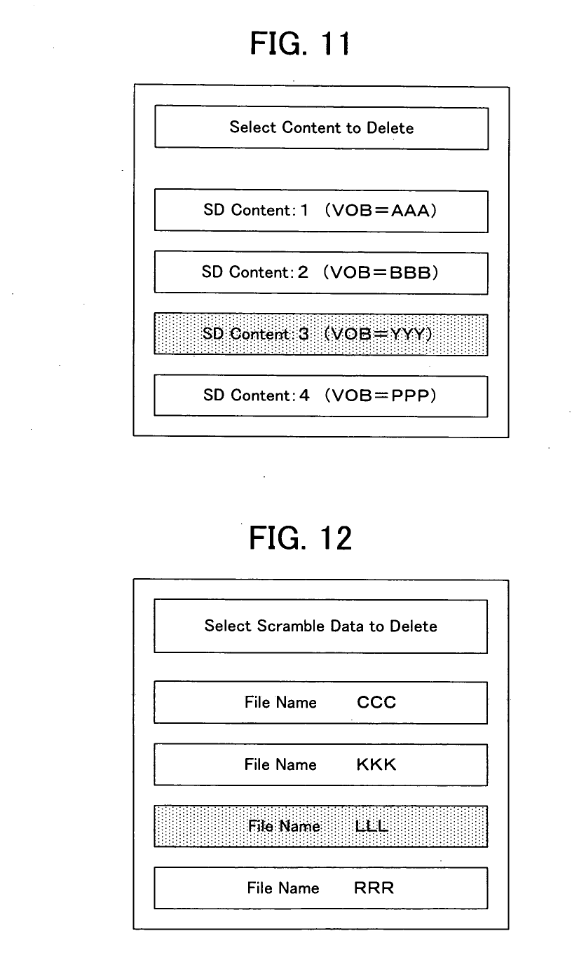

Moreover, if a plurality of SD contents are recorded on the optical disc 20, as shown in FIG. 11, it is also possible to display a window screen for letting a user select for which SD content the MOVE BACK processing is performed (or which SD content is deleted). Then, the processing shown in FIG. 10 is performed with respect to the SD content which is selected on this window screen.

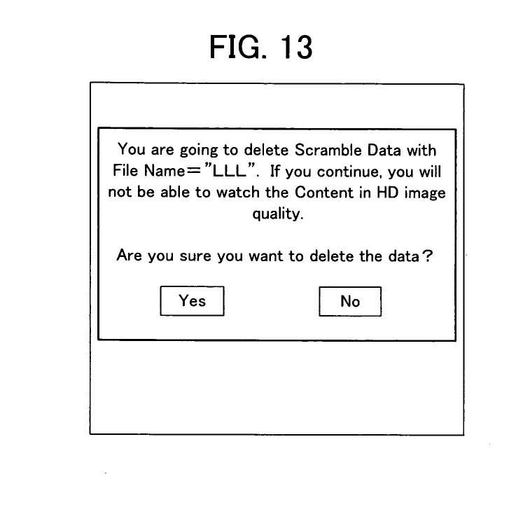

In addition, the scramble data recorded on the hard disk 10 may be deleted by the user's instruction, aside from the above-mentioned MOVE BACK processing or the like. In this case, it is possible to display a window screen which shows a list of the scramble data recorded on the hard disk 10, as shown in FIG. 12, to let the user select the scramble data that the user wants to delete. Then, if predetermined scramble data is selected by the user, as shown in FIG. 13, it is possible to display a screen for final confirmation about whether or not to delete it again. Namely, if the scramble data is deleted by the user's selection, it is impossible to reproduce the HD content corresponding to the scramble data, even if the user's selection is a mistake instruction. Thus, it is preferable to make the final confirmation.

Incidentally, the specifying of the scramble data recorded on the hard disk herein is performed in the following manner.

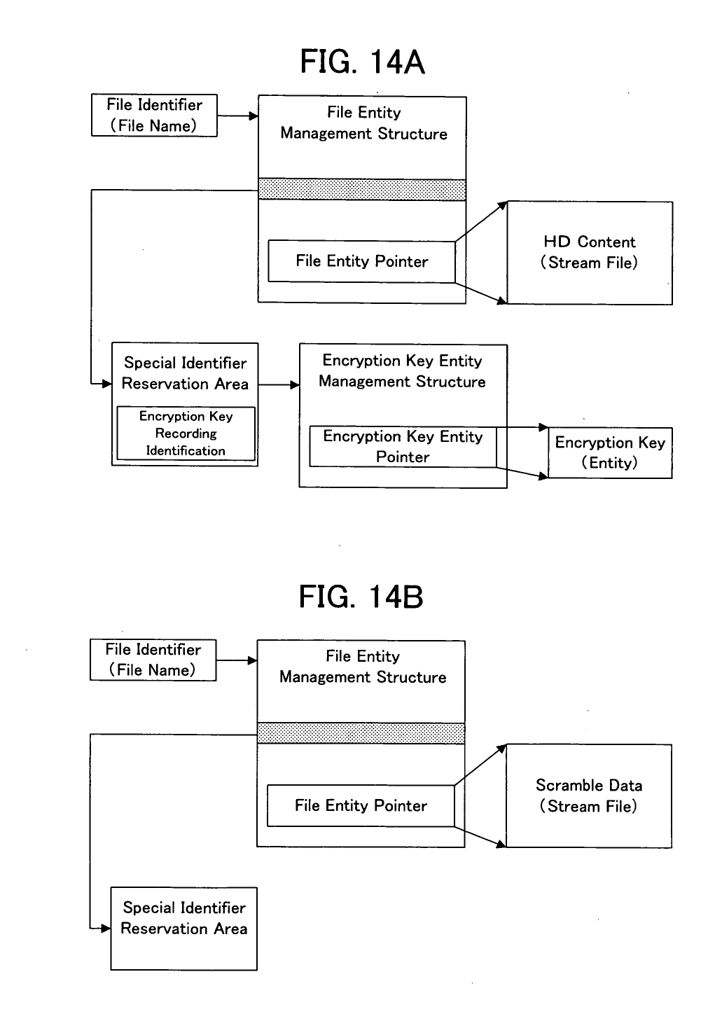

On the hard disk 10, the normal HD content (i.e. a file related to the HD content) is recorded with a data structure shown in FIG. 14A. As shown in FIG. 14A, a file identifier (i.e. the file name or the like) for specifying the HD content includes a pointer which indicates the address position of a file entity management structure for managing the entity of the HD content. The file entity pointer owned by the file entity management structure indicates the address position of the HD content on the hard disk 10. In addition, the file entity management structure includes a pointer to a special identifier reservation area. The special identifier reservation area includes a pointer for indicating the address position of an encryption key entity management structure for managing the entity of the encryption key, which defines the aspect or the like of encryption (e.g. local encryption) of the HD content on the hard disc 10. If the encryption processing is performed, the special identifier reservation area includes encryption key recording identification information. On the other hand, on the hard disk 10, the scramble data (i.e. a file related to the scramble data) is recorded with a data structure shown in FIG. 14B. As shown in FIG. 14B, the data structure about the file entity management structure is the same as in the normal HD content. However, the special identifier reservation area does not include the encryption key recording identification. Namely, the scramble data is recorded without encryption on the hard disk 10, so that the scramble data can be extracted by the presence or absence of this encryption key recording identification. Thus, the list shown in FIG. 12 can be displayed.

In the case of an information recording/reproducing apparatus which records the whole of the normal HD content without encryption, there is a possibility that the HD content and the scramble data cannot be distinguished. Therefore, it is preferable to perform the above-mentioned distinction and the extraction of the scramble data, in a predetermined directory where the HD content is recorded with encryption, in order to distinguishing the scramble data and the HD content.

If the constituent elements where the reproduction processing of the HD content is actually performed after this MOVE processing are extracted on a block diagram, they are as shown in FIG. 8. Namely, the above-mentioned reproduction processing of the HD content after the MOVE processing is performed mainly by the processing of the hard disk drive 11, the optical disc drive 21, the MPEG Demux 32, the video/audio decoder 33, the down-converter/TS-PS converter 34, the scramble/descramble circuit 35, the IDE controller 36, the ATAPI controller 37, the SW1, the SW2, and the SW3 and the like. Then, as the flow of data is shown in the thick line, the HD content is outputted from the scramble/descramble circuit 35 to the MPEG Demux 32, and further from the MPEG Demux 32 to the video/audio decoder 33. Moreover, as the flow of data is shown in the dashed line, the scramble data is outputted to the scramble/descramble circuit 35 through the IDE controller 36. Moreover, as the flow of data is shown in the two-dot chain line, the SD content is outputted to the MPEG Demux 32 through the ATAPI controller 37, and outputted from the MPEG Demux 32 to the video/audio decoder 33.

(3) Reproduction Processing of Reproducing SD Content or the Like After MOVE Processing

At first, the SD content or the like is read from the optical disc 20, and is decoded. Then, the decoded SD content is outputted to the MPEG Demux 32 through the ATAPI controller 37, and further from the MPEG Demux 32 to the video/audio decoder 33, to thereby reproduce the SD content. By this, a user can watch the SD content or the like recorded on the optical disc 20. In this case, since the content recorded on the optical disc 20 is reproduced, it is possible to reproduce the content (i.e. the SD content), regardless of whether or not there is the history information and whether or not the history information is correct.

On the other hand, as described above, in addition to or in place of the reproduction of the SD content as described above, the decoded SD content may be recorded onto the hard disk 10. Namely, the MOVE BACK processing (SD) may be performed. At this time, the history information is preferably recorded onto the hard disk 10. This is because the history information is necessary in the subsequent scramble processing. In particular, it is preferable to record the history information in association with the SD content.

The SD content recorded on the optical disc 20 is deleted in parallel with the recording processing of the SD content onto the hard disk 10 (the step S208). By this, it is possible to protect the copyright of the content. It is possible to reproduce the SD content from the hard disk 10.

In this case, it is preferable to remain the scramble data recorded on the hard disk 10, because it is necessary to reproduce the HD content.

Moreover, if the SD content is recorded on the hard disk 10, it is unnecessary to perform the relatively complicated data processing (e.g. down-converting, encoding, decoding, or the like), in recording the SD content and the history information, which are recorded on the hard disk 10, onto the optical disc 20 (i.e. in the MOVE processing). Thus, it is possible to realize the high-speed MOVE operation.

As explained above, according to the information recording/reproducing apparatus 1 in the embodiment, even after the HD content recorded on the hard disk 10 is converted to the SD content and it is recorded onto the optical disc 20, if the reproduction processing is performed by using the scramble data, it is possible to reproduce the HD content again. Even if the HD content is converted to the SD content and the SD content is recorded onto the optical disc 20, only the scramble data which is totally different from the SD content or the original HD content is recorded on the hard disk 10. Thus, a user can preferably watch the content related to the desired reproduction quality while the copyright of the content is properly protected.

In addition, by performing the descramble processing on the basis of the identifier and the history information, it is possible to preferably reproduce the HD content only if the scramble processing and the MOVE processing is properly performed. Thus, it is possible to preferably prevent the illegal reproduction of the illegally copied or duplicated HD content or the like. As a result, it is possible to protect the copyright of the content, more preferably.

In the above-mentioned embodiment, the hard disk 10 and the optical disc 20 are explained as one example of the recording medium, and the recorder (or player) related to the hard disk 10 and the optical disc 20 is explained as one example of the information recording/reproducing apparatus. The present invention, however, is not limited to the hard disk and the optical disc, and the recorder (or player) thereof, and can be adopted to other various recording media and the recorder (or player) thereof

The invention may be embodied in other specific forms without departing from the spirit or essential characteristics thereof The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-203154 filed on Jul. 9, 2004 including the specification, claims, drawings and summary is incorporated herein by reference in its entirety.

What is claimed is:

1. An information recording apparatus for performing MOVE processing of moving first content information having a first reproduction quality, which is recorded on a first recording medium, to a second recording medium,
said information recording apparatus comprising:
a scramble device for performing scramble processing of scrambling the first content information on the basis of a predetermined scramble key, to thereby generate scramble information;
an identifier storing device for storing an identifier to identify the second recording medium which is a MOVE destination of the first content information; and
a history information generating device for generating history information which indicates a history of each of the MOVE processing and the scramble processing.

2. The information recording apparatus according to claim 1, further comprising:
a down-convert device for down-converting the first content information, to thereby generate second content information having a second reproduction quality which is lower quality than the first reproduction quality;
a first recording device for recording the second content information onto the second recording medium; and
a deleting device for deleting the first content information recorded on the first recording medium if the second content information is recorded onto the second recording medium.

3. The information recording apparatus according to claim 2, wherein said first recording device further records the generated history information onto the second recording medium.

4. The information recording apparatus according to claim 1, wherein the history information includes information which can specify at least one of the scramble key, said information recording apparatus which performs the MOVE processing, the first content information to which the MOVE processing is performed, and a recording position of the second content information to which the MOVE processing is performed on the second recording medium.

5. The information recording apparatus according to claim 1, wherein the identifier is peculiar information to the second recording medium.

6. The information recording apparatus according to claim 1, further comprising: a second recording device for recording the scramble information onto the first recording medium.

7. The information recording apparatus according to claim 1, further comprising: a key generating device for generating the scramble key.

8. The information recording apparatus according to claim 1, further comprising:
an extracting device for extracting the scramble information on the basis of a difference in data structures of the first content information and the scramble information; and
a displaying device for displaying a list of the extracted scramble information.

9. An information recording method of performing MOVE processing of moving first content information having a first reproduction quality, which is recorded on a first recording medium, to a second recording medium, said information recording method comprising:
a scramble process of performing scramble processing of scrambling the first content information on the basis of a predetermined scramble key, to thereby generate scramble information;
an identifier storing process of storing an identifier to identify the second recording medium which is a MOVE destination of the first content information; and
a history information generating process of generating history information which indicates a history of each of the MOVE processing and the scramble processing.

10. An information reproducing apparatus for reproducing first content information which is moved onto a second recording medium by an information recording apparatus for performing MOVE processing of moving the first content information having a first reproduction quality, which is recorded on a first recording medium, to the second recording medium, said information recording apparatus comprising: a scramble device for performing scramble processing of scrambling the first content information on the basis of a predetermined scramble key, to thereby generate scramble information; an identifier storing device for storing an identifier to identify the second recording medium which is a MOVE destination of the first content information; and a history information generating device for generating history information which indicates a history of each of the MOVE processing and the scramble processing,
said information reproducing apparatus comprising:
a first judging device for judging whether or not an identifier of the second recording medium which is a reproduction object by said information reproducing apparatus is included in the identifier, which is stored in said identifier storing device, of the second recording medium which is the MOVE destination of the first content information;
an obtaining device for obtaining the history information if it is judged that the identifier of the second recording medium which is the reproduction object is included in the identifier of the second recording medium which is the MOVE destination of the first content information, by said judging device;
a content information generating device for generating the first content information on the basis of each of the scramble information and the scramble key which are specified by the history information; and
a reproducing device for reproducing the generated first content information.

11. The information reproducing apparatus according to claim 10, wherein
the history information is recorded on the second recording medium, said obtaining device obtains the history information from the second recording medium,
said information reproducing apparatus further comprises a second judging device for judging whether or not it is possible to reproduce the first content information on said information reproducing apparatus by referring to the obtained history information, and
said content information generating device generates the first content information if it is judged that it is possible to reproduce the first content information on said information reproducing apparatus, by said second judging device.

12. The information reproducing apparatus according to claim 10, further comprising:
an extracting device for extracting the scramble information on the basis of a difference in data structures of the first content information and the scramble information; and
a displaying device for displaying a list of the extracted scramble information.

13. An information reproducing method of reproducing first content information which is moved onto a second recording medium by an information recording apparatus for performing MOVE processing of moving the first content information having a first reproduction quality, which is recorded on a first recording medium, to the second recording medium, said information recording apparatus comprising: a scramble device for performing scramble processing of scrambling the first content information on the basis of a predetermined scramble key, to thereby generate scramble information; an identifier storing device for storing an identifier to identify the second recording medium which is a MOVE destination of the first content information; and a history information generating device for generating history information which indicates a history of each of the MOVE processing and the scramble processing,
said information reproducing method comprising:
a first judging process of judging whether or not an identifier of the second recording medium which is a reproduction object by said information reproducing apparatus is included in the identifier, which is stored in said identifier storing device, of the second recording medium which is the MOVE destination of the first content information;
an obtaining process of obtaining the history information if it is judged that the identifier of the second recording medium which is the reproduction object is included in the identifier of the second recording medium which is the MOVE destination of the first content information, by said judging process;
a content information generating process of generating the first content information on the basis of each of the scramble information and the scramble key which are specified by the history information; and
a reproducing process of reproducing the generated first content information.

14. An information recording/reproducing apparatus for performing MOVE processing of moving first content information having a first reproduction quality, which is recorded on a first recording medium, to a second recording medium,
said information recording/reproducing apparatus comprising:
a scramble device for performing scramble processing of scrambling the first content information on the basis of a predetermined scramble key, to thereby generate scramble information;
an identifier storing device for storing an identifier to identify the second recording medium which is a MOVE destination of the first content information;
a history information generating device for generating history information which indicates a history of each of the MOVE processing and the scramble processing;
a first judging device for judging whether or not an identifier of the second recording medium which is a reproduction object by said information reproducing apparatus is included in the identifier, which is stored in said identifier storing device, of the second recording medium which is the MOVE destination of the first content information;
an obtaining device for obtaining the history information if it is judged that the identifier of the second recording medium which is the reproduction object is included in the identifier of the second recording medium which is the MOVE destination of the first content information, by said judging device;
a content information generating device for generating the first content information on the basis of each of the scramble information and the scramble key which are specified by the history information; and
a reproducing device for reproducing the generated first content information.

15. The information recording/reproducing apparatus according to claim 14, wherein
the history information including information which can specify an information recording/reproducing apparatus which performs the MOVE processing is recorded on the second recording medium, said obtaining device obtains the history information from the second recording medium,
said information recording/reproducing apparatus further comprises a second judging device for judging whether or not the information recording/reproducing apparatus specified by the obtained history information coincides with said information recording/reproducing apparatus, and
said content information generating device generates the first content information if it is judged that the information recording/reproducing apparatus specified by the obtained history information coincides with said information recording/reproducing apparatus, by said second judging device.

16. The information recording/reproducing apparatus according to claim 14, further comprising:
an extracting device for extracting the scramble information on the basis of a difference in data structures of the first content information and the scramble information; and
a displaying device for displaying a list of the extracted scramble information.

17. An information recording/reproducing method of performing MOVE processing of moving first content information having a first reproduction quality, which is recorded on a first recording medium, to a second recording medium,
said information recording/reproducing method comprising:
a scramble process of performing scramble processing of scrambling the first content information on the basis of a predetermined scramble key, to thereby generate scramble information;
an identifier storing process of storing an identifier to identify the second recording medium which is a MOVE destination of the first content information;
a history information generating process of generating history information which indicates a history of each of the MOVE processing and the scramble processing;
a first judging process of judging whether or not an identifier of the second recording medium which is a reproduction object by said information reproducing apparatus is included in the identifier, which is stored in said identifier storing device, of the second recording medium which is the MOVE destination of the first content information;
an obtaining process of obtaining the history information if it is judged that the identifier of the second recording medium which is the reproduction object is included in the identifier of the second recording medium which is the MOVE destination of the first content information, by said judging process;
a content information generating process of generating the first content information on the basis of each of the scramble information and the scramble key which are specified by the history information; and
a reproducing process of reproducing the generated first content information.

18. A computer program product in a computer-readable medium for tangibly embodying a program of instructions executable by a computer provided in an information recording apparatus for performing MOVE processing of moving first content information of a first reproduction quality, which is recorded on a first recording medium, to a second recording medium, the information recording apparatus comprising: a scramble device for performing scramble processing of scrambling the first content information on the basis of a predetermined scramble key, to thereby generate scramble information; a identifier storing device for storing an identifier to identify the second recording medium which is a MOVE destination of the first content information; and a history information generating device for generating history information which indicates a history of each of the MOVE processing and the scramble processing to make the computer function as at least one portion of the scramble device, the identifier string device, and the history information generating device.

19. A computer program product in a computer-readable medium for tangibly embodying a program of instructions executable by a computer provided in an information reproducing apparatus for reproducing first content information which is moved onto a second recording medium by an information recording apparatus for performing MOVE processing of moving the first content information of a first reproduction quality, which is recorded on a first recording medium, to the second recording medium, said information recording apparatus comprising: a scramble device for performing scramble processing of scrambling the first content information on the basis of a predetermined scramble key, to thereby generate scramble information; an identifier storing device for storing an identifier to identify the second recording medium which is a MOVE destination of the first content information; and a history information generating device for generating history information which indicates a history of each of the MOVE processing and the scramble processing, the information reproducing apparatus comprising: a first judging device for judging whether or not an identifier of the second recording medium which is a reproduction object by said information reproducing apparatus is included in the identifier of the second recording medium which is the MOVE destination of the first content information, the identifier being stored in said identifier storing device; a obtaining device for obtaining the history information if it is judged “included” by said judging device; a content information generating device for generating the first content information on the basis of each of the scramble information and the scramble key which are specified by the history information; and a reproducing device for reproducing the generated first content information to make the computer function as at least one portion of the first judging device, the obtaining device, the content information generating device, and the reproducing device.

20. A computer program product in a computer-readable medium for tangibly embodying a program of instructions executable by a computer provided in an information recording/reproducing apparatus for performing MOVE processing of moving first content information of a first reproduction quality, which is recorded on a first recording medium, to a second recording medium, the information recording/reproducing apparatus comprising: a scramble device for performing scramble processing of scrambling the first content information on the basis of a predetermined scramble key, to thereby generate scramble information; an identifier storing device for storing an identifier to identify the second recording medium which is a MOVE destination of the first content information; a history information generating device for generating history information which indicates a history of each of the MOVE processing and the scramble processing; a first judging device for judging whether or not an identifier of the second recording medium which is a reproduction object by said information reproducing apparatus is included in the identifier of the second recording medium which is the MOVE destination of the first content information, the identifier being stored in said identifier storing device; an obtaining device for obtaining the history information if it is judged “included” by said judging device; a content information generating device for generating the first content information on the basis of each of the scramble information and the scramble key which are specified by the history information; and a reproducing device for reproducing the generated first content information to make the computer function as at least one portion of the scramble device, the identifier string device, the history information generating device, the first judging device, the obtaining device, the content information generating device, and the reproducing device.
